(19) United States
(12) Patent Application Publication
(10) Pub. No.: US 2012/0042332 A1
(43) Pub. Date: Feb. 16, 2012

(54) Method and system for providing encrypted content to a plurality of user devices

(76) Inventor: Andrew Augustine Wajs, Haarlem (NL)

(21) Appl. No.: 12/854,335

(22) Filed: Aug. 11, 2010

(30) Foreign Application Priority Data
Aug. 11, 2010 (EP) PCT/EP2010/061711

(51) Int. Cl. H04N 7/167; H04L 9/00

(52) U.S. Cl. 725/31; 713/150; 713/162

(57) ABSTRACT

The invention relates to a system and computer-implemented method for providing encrypted content to a particular recipient device of a plurality of recipient devices is disclosed. Copies of one or more content elements of the content are generated. Modified content elements are obtained by modifying one or more of the copies. The content elements, including the one or more modified copies of the content elements, are then stored in a storage. A sequence of content elements representing the content is retrieved from the storage for a particular recipient device of the plurality of recipient devices by selecting a particular modified copy for substantially each content element for which modified copies are available. The sequence of content elements is then encrypted for that particular recipient device. The encrypted sequence of content elements representing the encrypted content is sent to the particular recipient device.

### FIELD OF THE INVENTION

The invention relates to the field of providing encrypted content to a plurality of user devices. More specifically, the invention relates to the field of providing encrypted content composed of a plurality of content elements to a plurality of user devices, e.g. for video-on-demand applications.

### BACKGROUND OF THE INVENTION

Premium content, such as pay television in e.g. video-on-demand applications, continue to require protection in order to prevent unauthorized access to such content and to detect leaks in the protection. Encryption and watermarking are known to respectively fulfil such needs. Encryption involves e.g. the encryption of content by a sender using an encryption key, wherein the encrypted content is transmitted to the receiver and the encrypted content is decrypted in the receiver using a decryption key. Watermarking involves the insertion of unique information into the content in a non-removable manner and in a manner typically not or hardly noticeable for the user at the receiving side. Watermarking allows the identification of a source re-distributing premium content without authorization.

US 2003/009669 discloses a method and system for distributing content while providing reliable content protection and watermarking. The method and system comprise encrypting a copy of at least part of the content having a first watermark and also encrypting a copy of at least part of the content having a second water mark. Parts of the encrypted copy with the first watermark and parts of the encrypted copy with the second watermark are combined in a manner unique for an individual recipient device. As such, content is distributed while providing reliable content protection and watermarking.

In the prior art solution, the selection of the watermark and the selection of the encryption key are linked which requires some form of coordination between the watermarking step and the subsequent encryption step. The encryption engine should be able to recognize different copies of a frame of the content (i.e. copies having the same time base) and should be able to provide different encryption keys for different copies of an identical frame of the content.

### SUMMARY OF THE INVENTION

It is an object of the invention to provide a method and system allowing content modification, such as watermarking, and encryption of content in an improved manner.

To that end, in one aspect of the invention, a computer-implemented method for providing encrypted content to a particular recipient device of a plurality of recipient devices is disclosed. Copies of one or more content elements of the content are generated. Modified content elements are obtained by modifying one or more of the copies. The content elements, including the one or more modified copies of the content elements, are then stored in a storage. A sequence of content elements representing the content is retrieved from the storage for a particular recipient device of the plurality of recipient devices by selecting a particular modified copy for substantially each content element for which modified copies are available. The selection may be performed such that differently modified copies of different content elements are included in the sequence. The sequence of content elements is then encrypted for that particular recipient device. The encrypted sequence of content elements representing the encrypted content is sent to the particular recipient device.

In one further aspect of the invention, a transmission system for providing encrypted content to a particular recipient device of a plurality of recipient devices over a network is disclosed. The transmission system comprises a copy generator configured for generating copies of one or more content elements of the content and a modifying module configured for modifying one or more of the copies to obtain modified copies of the one or more content elements. The transmission system comprises a storage configured for storage of the content elements, including the one or more modified copies of the content elements. A selector is configured for selecting a particular modified copy for substantially each content element for which modified copies are available in the storage to provide a sequence of content elements representing the content for the particular recipient device. The selection may be performed such that differently modified copies of different content elements are included in the sequence. The transmission system comprises an encrypting module configured for encrypting the sequence of content elements for and a transmitter configured for providing the encrypted sequence of content elements representing the encrypted content to the particular recipient device.

By delaying the encryption step to a stage after which the selection of the modified copies has been performed and the sequence of content elements destined for a particular recipient device has been obtained, the method and system enable the encryption function to be applied to a linear sequence of content elements for the particular recipient device instead of to a sequence of content elements containing alternative copies for at least some content elements from which a selection should still be made for that particular recipient device. Key cycling for encryption can be performed independent of the modification of the content elements. Selection and/or encryption may be performed in real time when the content is played out.

Advantageous embodiments of modifying content elements include the provision of different watermarks in copies of a content element and/or the application of different encoding characteristics for a content element prior to storage of the content elements.

In one embodiment of the invention, copies of at least one content element are provided with different watermarks prior to storage. The sequence of content elements is personalized for a particular recipient device or session with the device by selecting different particular copies with watermarks to obtain a unique combination of watermarks for that device or session. Personalization to obtain the unique combination of watermarks may be performed in real time when the content is played out. The unique combination of watermarks enables tracing a recipient device redistributing the content without authorization after decryption. In the embodiment of claim 3, the watermark identifier serves as an identifier for the selection of the unique combination of watermarks and linking this unique combination to the particular recipient device and/or session with the particular recipient device.

In another embodiment of the invention, copies of at least one content element are provided with different encoding characteristics prior to storage. Examples of different encoding characteristics include, but are not limited to, different bit rates, different video resolution, different video formats etc. The sequence of content elements with different encoding characteristics is preferably determined in real time by selecting the content element with a particular encoding characteristic for one or more content elements when the content elements are played out. Selection of the content elements can be based on the available bandwidth on a network towards the recipient for which the sequence of content elements is intended. The server from which the content elements are provided may be equipped with a monitoring module for monitoring the available bandwidth in real time. Selection of content elements may also be based on user input from a user of the recipient device.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 is a schematic illustration of a system for providing encrypted content according to an embodiment of the invention;

FIG. 2 is a schematic diagram illustrating the operation of the system of FIG. 1 according to an embodiment of the invention;

FIGS. 3A and 3B illustrate advantageous examples of operation of the system according to FIG. 1;

FIG. 4 is a schematic diagram illustrating multi-modification operation according to an embodiment of the invention; and

FIG. 5 is a schematic diagram illustrating an alternative of multi-modification operation of FIG. 4.

### DETAILED DESCRIPTION OF THE DRAWINGS

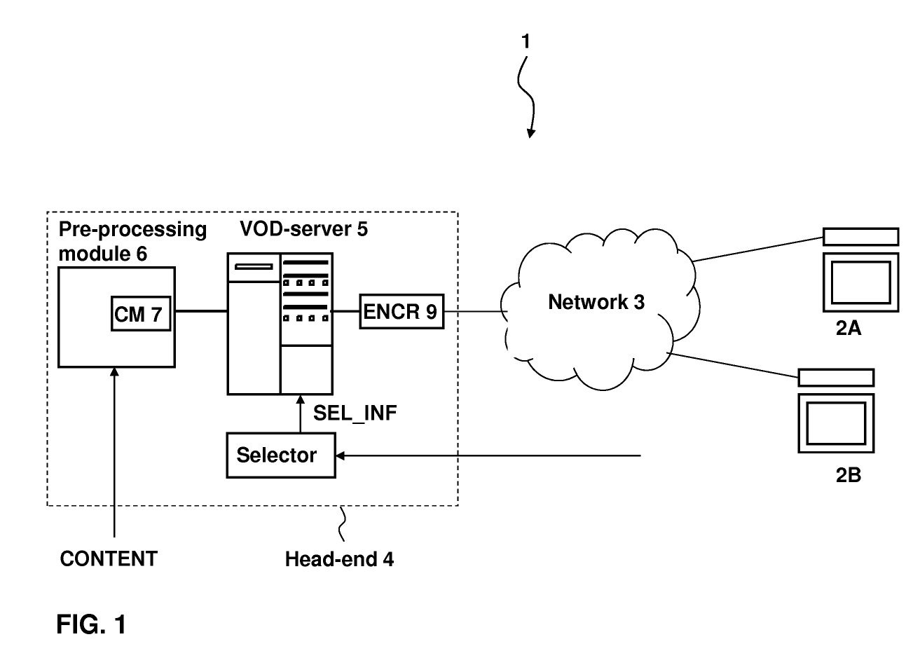

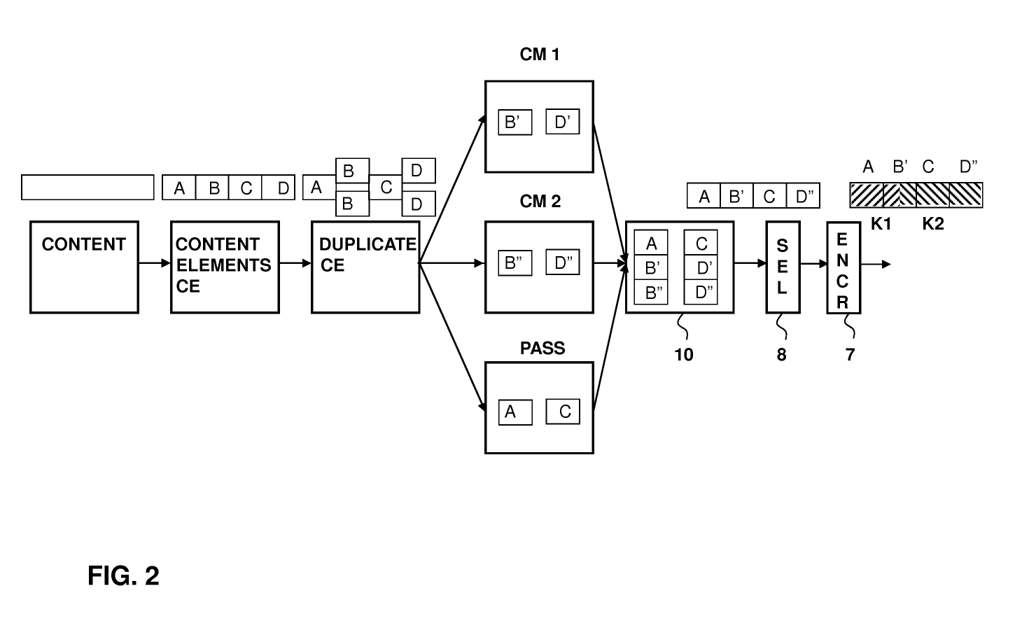

FIG. 1 is an illustration of a system 1 for providing encrypted content to a particular recipient device 2A of a plurality of recipient devices 2A, 2B over a network 3. Network 3 may e.g. contain a cable distribution network. The system 1 employs a head-end 4 comprising a video-on-demand (VOD) server 5 receiving input from a pre-processing module 6. VOD server 5 comprises a storage 10 (see FIG. 2) for storing content elements CE, as will be explained in more detail with reference to FIGS. 2-5. The VOD server 5 may represent a system of VOD servers, each of the VOD servers being located near a subset of recipient devices. The content elements may be stored in VOD server 5 in protected form, e.g. using a fixed key or an encrypted disk volume.

The pre-processing module 6 comprises an input for receiving clear content and comprises a content modifier CM 7. The output of the pre-processing module 6 is connected to the input of the VOD server 5.

VOD server 5 furthermore comprises an input for receiving selection information SEL_INF from a selector 8. Selector 8 contains an information receiving and processing module for receiving and processing information. Such information may relate to a state of the network 3 or a particular connection of that network or may relate to input from users of the recipient devices 2A, 2B. Selection of content elements can be performed in real time, e.g. when a VOD request is received and the content elements about to be played out.

The output from VOD-server 5 passes an encryption module 9. Encryption module 9 can be a real time encryption module

FIG. 2 is a schematic diagram illustrating an example of the operation of the system 1 depicted in FIG. 1.

In a first step, clear content is received at the pre-processing module 6. Preprocessing module 6 may, in one embodiment, divide at least a part of the received content in content elements CE. A few content elements CE are indicated by letters “A”, “B”, “C” and “D”, respectively. In a next stage, copies of one or more content elements CE are provided. In the example of FIG. 2, content elements B and D are duplicated, i.e. some content elements are provided of identical content for identical time intervals of the time base. The result of the copying step is that now six content elements A, B, B, C, D and D are available. These content elements CE are input to a content modifier 7 that processes the duplicated content elements CE such that a first content element B, D is modified in a first manner CM1 resulting in content elements B′, D′, whereas the second content element B, D is modified in a second manner CM2 resulting in content elements B″, D″. In the example of FIG. 2, content elements CE for which no copies have been obtained are not modified by content modifier CM 7. The content elements, A, B′, B″, C, D′ and D″ are then stored in storage 10. Of course, it may be possible to also put B and D in the storage 10 which may be practical e.g. when the decision to use one or more modified content elements CE (e.g. watermarked content elements) is postponed.

When the content should be provided to a particular recipient device, e.g. recipient device 2A, selector 8 selects particular content elements CE to provide a stream of content elements A, B′, C, D″ to encryption module 9. The stream of content elements CE is a linear sequence of subsequent content elements (i.e. not comprising duplicates) representing the content for the recipient device 2A. The linear seamless stream of content elements is encrypted by encryption module 9 in a conventional manner without requiring coordination between the content modifier 7 and the encryption module 9. As shown in FIG. 2 by the differently hatched areas in the content stream, the encryption key can be cycled from key K1 to key K2 at a point in time during which a particular content element B′ is played out.

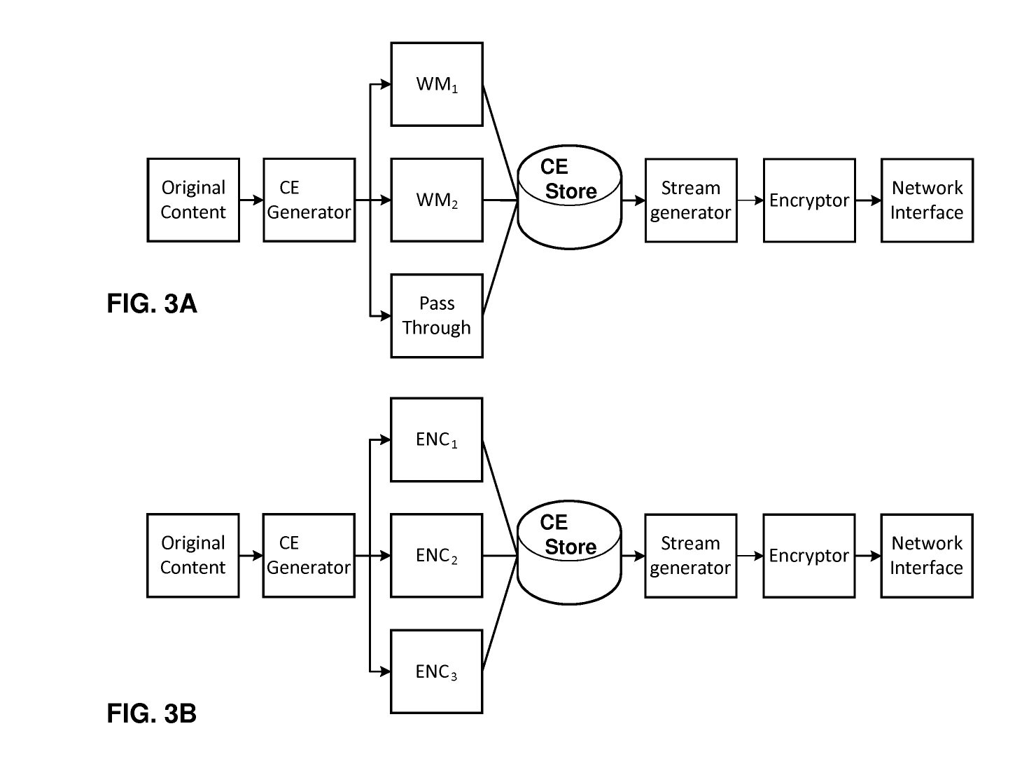

Some embodiments of the present invention will now be described in further detail with reference to FIGS. 3A and 3B. In the embodiment of FIG. 3A, watermarking is depicted as a particular form of content modification, whereas in FIG. 3B, content modification takes the form of providing copies with different encoding characteristics for one or more content elements.

In the embodiment of FIG. 3A, content encryption is performed after personalization of a watermark for a particular recipient device 2A. Content elements of clear content are first duplicated and copies of content elements are subsequently provided with different watermarks WM1, WM2, while content elements for which no copies are generated. All content elements CE are stored in a storage CE Store, either with or without a watermark. The watermarking process, therefore, does not need to be performed in real time but pre-watermarked content elements can be stored in advance. For watermarking, only a small percentage of the content elements is typically required to contain a watermark and depends e.g. on the required watermark detection rate. A personalized stream of selected content elements, i.e. a stream of content elements with a unique combination of watermarks WM1, WM2, is only provided to the particular recipient device 2A only when the content is required to be played out. The VOD server 5 is instructed to switch between different watermarked content elements CE in a pattern driven be selection information SEL_INF from a selection module 8. Such selection information may e.g. comprise a watermark identifier that can be provided on a per recipient device 2A, 2B or a per-session basis. The watermark identifier uniquely links the resulting combination of watermarks in the content elements that can be extracted after decryption to a recipient device 2A.

The personalized stream of content elements CE is encrypted to provide reliable protection of the content while transferring the content over the network 3. At the recipient device 2A, the content elements CE are decrypted and can be rendered by the device 2A while still containing the unique combination of watermarks. As such, when a user of the recipient device 2A would re-distribute the content, the combination of watermarks would allowing tracing the user as the source of unauthorized re-distribution of the content.

The embodiment of FIG. 3B provides for a different form of content modification by storing copies of one or more content elements with different encoding characteristics, e.g. different bit rates. In this embodiment, triple copies are provided for each content element CE and subsequently fed to three different encoders ENC₁, ENC₂ and ENC₂. Thereafter, the content elements are stored in the CE store. The head-end 4 may switch during playing out a stream of content elements to provide content to recipient device 3B between content elements CE with different encoding characteristics by monitoring information from the network 3, e.g. the state of the connection between head-end 4 and recipient device 2A. As an example, when the available bandwidth is temporarily reduced for the connection, the head-end 4 may decide to select content elements CE with a lower bit rate instead of the higher bit rate for the duration of the constrained bandwidth.

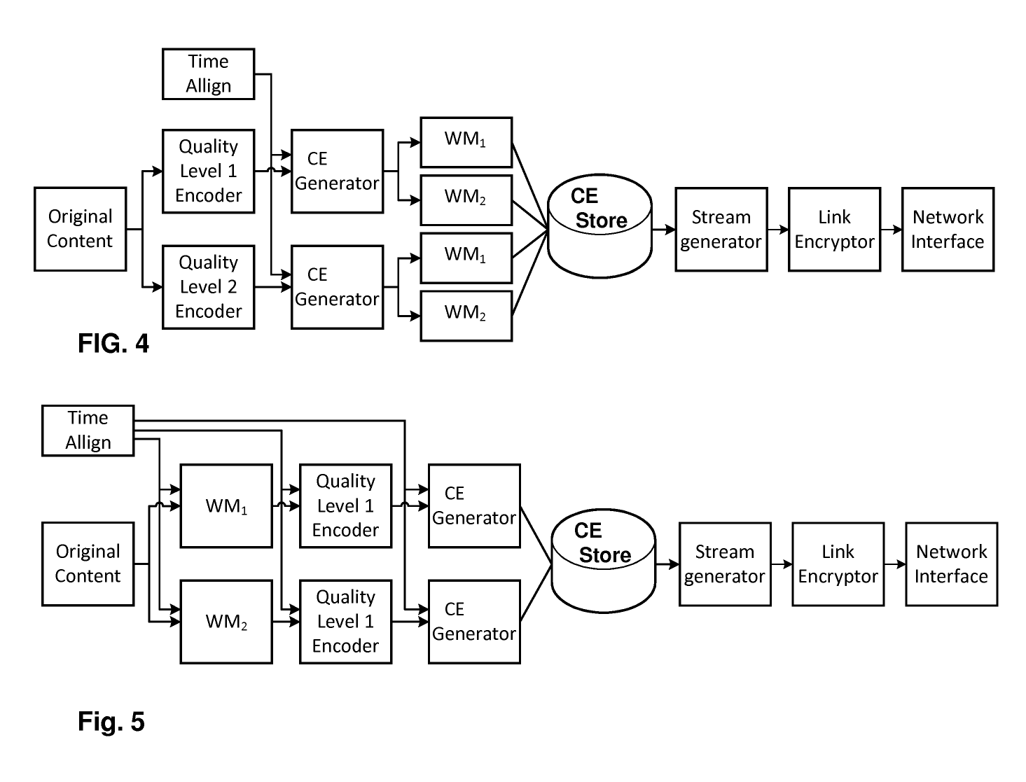

The embodiments of FIGS. 4 and 5 depict multi-modification schemes combining providing different watermarks and different encoding characteristics, indicated as quality levels, for different copies of content elements. Moreover, these diagrams illustrate that the formation of content elements CE can be performed at any stage prior to the storage of the content elements.

In the embodiment of FIG. 4, the original content is duplicated each of the copies is encoded in a different manner, e.g. a different bit rate is applied. Time alignment is performed to allow content synchronization between the copies to enable subsequent generation of corresponding content elements for each of the copies. After the content elements CE are generated, each content element CE for each encoding characteristic is modified further by insertion of a watermark WM₁, WM₂. The resulting content elements are stored in the storage CE store. When content needs to be played out, content elements are selected for form a stream of content elements CE representing the requested content having a unique combination of watermarks WM₁ and WM₂ for a particular recipient device 2A that can be adapted further by choosing between content elements having different encoding characteristics if a need to do is detected by the head-end 4. Encryption of the resulting stream of content elements is performed as a final step prior to putting the stream on the network.

The embodiment depicted in FIG. 5 provides yet another alternative again combining watermarking and quality levels while only generating content elements CE as a final step prior to storage but after watermarking and quality level variation applied to the original content. Time alignment of the original content is maintained up to the stage of content element generation.

One embodiment of the invention may be implemented as a program product for use with a computer system. The program(s) of the program product define functions of the embodiments (including the methods described herein) and can be contained on a variety of non-transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

While the forgoing is directed to embodiments of the present invention, other and further embodiments of the invention may be devised without departing from the basic scope thereof. For example, aspects of the present invention may be implemented in hardware or software or in a combination of hardware and software. Therefore, the scope of the present invention is determined by the claims that follow.

1. A computer-implemented method for providing encrypted content to a particular recipient device of a plurality of recipient devices, the method comprising the steps of:
generating copies of one or more content elements of the content;
modifying one or more of the copies to obtain modified copies of the one or more content elements;
storing the content elements, including the one or more modified copies of the content elements, in a storage;
retrieving a sequence of content elements representing the content from the storage for the particular recipient device by selecting a particular modified copy for substantially each content element for which modified copies are available;
encrypting the sequence of content elements for the particular recipient device;
providing the encrypted sequence of content elements representing the encrypted content to the particular recipient device.

2. The method according to claim 1, wherein the step of modifying the copies of the one or more content elements comprises the step of providing different watermarks in different copies of a content element for at least some content elements and wherein the sequence of content elements is retrieved by selecting particular copies with watermarks to obtain a unique combination of watermarks for the particular recipient device.

3. The method according to claim 2, wherein the step of selecting particular copies with watermarks is driven by a watermark identifier, the watermark identifier linking the sequence of content elements with the unique combination of watermarks to the particular recipient device and/or session for the particular recipient device.

4. The method according to claim 1, wherein the step of modifying the copies of the one or more content elements comprises the step of providing different encoding characteristics in different copies of a content element and wherein the sequence of content elements representing the content comprises content elements with different encoding characteristics.

5. The method according to claim 4, wherein the content elements with different encoding characteristics are selected at a transmission system for content transmission by receiving information regarding at least one of:
available bandwidth from the transmission system to a particular recipient device;
user input from a user of the particular recipient device.

6. The method according to claim 1, wherein the method is at least partly executed in a video-on-demand system.

7. A system for providing encrypted content to a particular recipient device of a plurality of recipient devices over a network, wherein the transmission system comprises:
a copy generator configured for generating copies of one or more content elements of the content;
a modifying module configured for modifying one or more of the copies to obtain modified copies of the one or more content elements;
a storage configured for storage of the content elements, including the one or more modified copies of the content elements;
a selector configured for selecting a particular modified copy for substantially each content element for which modified copies are available in the storage to provide a sequence of content elements representing the content for the particular recipient device;
an encrypting module configured for encrypting the sequence of content elements for the particular recipient device;
a transmitter configured for providing the encrypted sequence of content elements representing the encrypted content to the particular recipient device.

8. The system according to claim 7, wherein the modifying module comprises a watermarking module configured for providing different watermarks in different copies of a content element for at least some content elements and wherein the selector is configured for retrieving the sequence of content elements by selecting particular copies with watermarks to obtain a unique combination of watermarks for the particular recipient device.

9. The system according to claim 8, further comprising a watermark identifier module for providing a watermark identifier driving the selector to select particular copies of content elements with watermarks, the watermark identifier linking the sequence of content elements with the unique combination of watermarks to the particular recipient device and/or session for the particular recipient device.

10. The system according to claim 7, wherein the modifying module comprises a plurality of encoders configured for providing different encoding characteristics for different copies of at least one content element and wherein the selector is configured to for retrieving content elements with different encoding characteristics representing the content.

11. The system according to claim 10, further comprising an information processing system configured for receiving and processing information regarding at least one of:
available bandwidth from the transmission system to a particular recipient device;
user input from a user of the particular recipient device+ and wherein the selector is configured to select content elements with different encoding characteristics in dependence of a processing result from the information processing system.

12. The system according to one or more of the preceding claim 7, wherein the system comprises a video-on-demand system.
